(19) United States
(12) Patent Application Publication
(10) Pub. No.: US 2022/0066455 A1
(43) Pub. Date: Mar. 3, 2022

(54) AUTONOMOUS MOBILE ROBOT CONTROL SYSTEM, CONTROL METHOD THEREOF, A NON-TRANSITORY COMPUTER READABLE MEDIUM STORING CONTROL PROGRAM THEREOF, AND AUTONOMOUS MOBILE ROBOT CONTROL DEVICE

(71) Applicant: TOYOTA JIDOSHA KABUSHIKI KAISHA, Toyota-shi (JP)

(72) Inventors: Tomohisa TAKAI, Nagoya-shi (JP); Yuhei YAMAGUCHI, Toyota-shi (JP); Satoshi TOYOSHIMA, Okazaki-shi (JP); Yuta WATANABE, Toyota-shi (JP); Tetsuya TAIRA, Nagakute-shi (JP); Mikio HONDA, Toyota-shi (JP); Shiro ODA, Anjo-shi (JP); Nobuhisa OTSUKI, Toyota-shi (JP)

(73) Assignee: TOYOTA JIDOSHA KABUSHIKI KAISHA, Toyota-shi (JP)

(21) Appl. No.: 17/392,568

(22) Filed: Aug. 3, 2021

(30) Foreign Application Priority Data
Aug. 26, 2020 (JP) 2020-142718

(51) Int. Cl. G05D 1/02; G05D 1/00; B60W 60/00

(52) U.S. Cl. CPC G05D 1/0214; G05D 1/0251; G05D 1/0088; B60W 2554/406; G05D 2201/0206; B60W 2420/42; B60W 60/0025

(57) ABSTRACT

To effectively prevent an autonomous mobile robot from interfering with the flow of people, an autonomous mobile robot control system includes an autonomous mobile robot, a host management device that manages the autonomous mobile robot on the basis of a route plan defining a moving route of the autonomous mobile robot, and a plurality of environmental cameras that capture images of a moving range of the autonomous mobile robot and transmit the captured images to the host management device. The host management device estimates transition of a degree of congestion in a period later than present time in each of a plurality of management areas defined by dividing an operating range of the autonomous mobile robot on the basis of environmental information acquired using the plurality of environmental cameras, and updates the route plan on the basis of an estimated result of transition of the degree of congestion.

### CROSS REFERENCE TO RELATED APPLICATIONS

This application is based upon and claims the benefit of priority from Japanese patent application No. 2020-142718, filed on Aug. 26, 2020, the disclosure of which is incorporated herein in its entirety by reference.

### BACKGROUND

The present disclosure relates to an autonomous mobile robot control system, its control method, its control program, and an autonomous mobile robot control device.

An autonomous mobile device that autonomously moves in a specified building or facility is under development. Such an autonomous mobile device can serve as a self-driving delivery device that has a carriage or tows a trolley and automatically delivers a package. The self-driving delivery device autonomously moves from the place of departure to the destination and can thereby deliver a package loaded at the place of departure to the destination, for example.

For example, the self-driving delivery device disclosed in U.S. Pat. No. 9,026,301 includes a towing unit and a carriage unit, and a computer included therein stores an electronic map of a floor plan of a building and a path to be followed when moving from one place to another. This self-driving delivery device carries a variety of goods by using different types of carriage units depending on purpose.

### SUMMARY

However, a facility in which an autonomous mobile robot is put into operation has an environment where people and the autonomous mobile robot exist together, and the environment is subject to constant change with the movement of people and objects. Therefore, merely putting the autonomous mobile robot into operation on the basis of a predetermined path, as in the case of the self-driving delivery device disclosed in U.S. Pat. No. 9,026,301, raises a problem that the autonomous mobile robot limits the movement of people.

The present disclosure has been accomplished to solve the above problem and an object of the present disclosure is thus to reduce the situations where the autonomous mobile robot interferes with people's movements.

An autonomous mobile robot control system according to one aspect of the present disclosure includes an autonomous mobile robot;

a host management device configured to manage the autonomous mobile robot on the basis of a route plan defining a moving route of the autonomous mobile robot, and a plurality of environmental cameras configured to capture images of a moving range of the autonomous mobile robot and transmit the captured images to the host management device, wherein for each of a plurality of management areas defined by dividing an operating range of the autonomous mobile robot, the host management device estimates transition of a degree of congestion in the management area in a period later than present time on the basis of environmental information acquired using the plurality of environmental cameras, and the host management device updates the route plan on the basis of an estimated result of transition of the degree of congestion.

An autonomous mobile robot control method according to one aspect of the present disclosure is an autonomous mobile robot control method in an autonomous mobile robot control system including a host management device configured to manage an autonomous mobile robot on the basis of a route plan defining a moving route of the autonomous mobile robot, and a plurality of environmental cameras configured to capture images of a moving range of the autonomous mobile robot and transmit the captured images to the host management device, the method including estimating, by the host management device, transition of a degree of congestion in a period later than present time in each of a plurality of management areas defined by dividing an operating range of the autonomous mobile robot on the basis of environmental information acquired using the plurality of environmental cameras, and updating, by the host management device, the route plan on the basis of an estimated result of transition of the degree of congestion.

An autonomous mobile robot control program according to one aspect of the present disclosure is an autonomous mobile robot control program executed in a host management device of an autonomous mobile robot control system including the host management device configured to manage an autonomous mobile robot on the basis of a route plan defining a moving route of the autonomous mobile robot, and a plurality of environmental cameras configured to capture images of a moving range of the autonomous mobile robot and transmit the captured images to the host management device, including estimating transition of a degree of congestion in a period later than present time in each of a plurality of management areas defined by dividing an operating range of the autonomous mobile robot on the basis of environmental information acquired using the plurality of environmental cameras, and updating the route plan on the basis of an estimated result of transition of the degree of congestion.

An autonomous mobile robot control device according to one aspect of the present disclosure includes a host management device configured to manage an autonomous mobile robot on the basis of a route plan defining a moving route of the autonomous mobile robot, and a plurality of environmental cameras configured to capture images of a moving range of the autonomous mobile robot and transmit the captured images to the host management device, wherein for each of a plurality of management areas defined by dividing an operating range of the autonomous mobile robot, the host management device estimates transition of a degree of congestion in the management area in a period later than present time on the basis of environmental information acquired using the plurality of environmental cameras, and the host management device updates the route plan on the basis of an estimated result of transition of the degree of congestion.

The autonomous mobile robot control system, its control method, its control program, and the autonomous mobile robot control device according to the present disclosure update a route plan according to an environmental change detected by environmental cameras.

According to the present disclosure, there are provided an autonomous mobile robot control system, a control method of the same, a control program of the same, and an autonomous mobile robot control device that reduce the frequency that an autonomous mobile robot interferes with people's movements.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a block diagram of an autonomous mobile robot control system according to a first embodiment;

FIG. 2 is a schematic view of an autonomous mobile robot according to the first embodiment;

FIG. 3 is a view illustrating the situation where the movement lines of people and the autonomous mobile robot cross over, which occurs when the autonomous mobile robot according to the first embodiment is put into operation;

FIG. 4 is a view illustrating the situation where an object is placed in a passage for a certain period of time, which occurs when the autonomous mobile robot according to the first embodiment is put into operation;

FIG. 5 is a flowchart illustrating the operation of the autonomous mobile robot control system according to the first embodiment; and

FIG. 6 is a block diagram of an autonomous mobile robot control system according to a second embodiment.

### DESCRIPTION OF EMBODIMENTS

The following description and the attached drawings are appropriately shortened and simplified to clarify the explanation. Further, elements that are shown in the drawings as functional blocks for performing various kinds of processing may be configured by a CPU (Central Processing Unit), a memory or another circuit as hardware or may be implemented by a program loaded to a memory or the like as software. It would be thus obvious to those skilled in the art that those functional blocks may be implemented in various forms such as hardware only, software only or a combination of those, and not limited to either one. In the figures, the identical reference symbols denote identical structural elements and the redundant explanation thereof is omitted.

Further, the above-described program can be stored and provided to the computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R , CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

Further, although a hospital is used as an example of a facility to which the autonomous mobile robot control system is applied, the autonomous mobile robot control system may be applied to various facilities, not limited to a hospital.

### First Embodiment

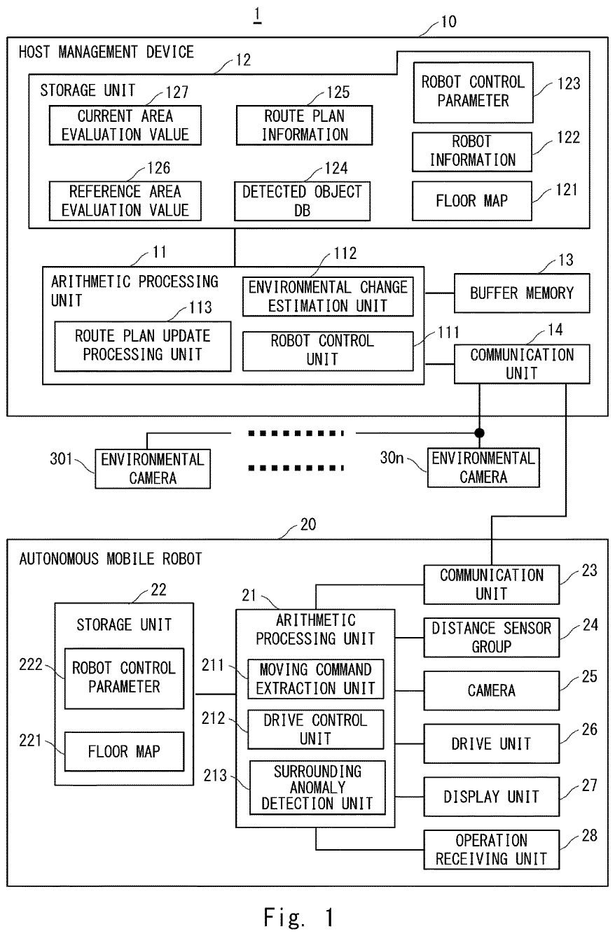

FIG. 1 is a block diagram of an autonomous mobile robot control system 1 according to a first embodiment. As shown in FIG. 1, the autonomous mobile robot control system 1 according to the first embodiment includes a host management device 10, an autonomous mobile robot (e.g., an autonomous mobile robot 20), and environmental cameras 301 to 30n. Although only one autonomous mobile robot 20 is shown in FIG. 1, the autonomous mobile robot control system 1 includes a plurality of autonomous mobile robots 20 in this example. This autonomous mobile robot control system 1 allows the autonomous mobile robots 20 to move autonomously in a specified facility and efficiently controls the plurality of autonomous mobile robots 20. To achieve this, the autonomous mobile robot control system 1 places the plurality of environmental cameras 301 to 30n in the facility and thereby acquires images in the range where the autonomous mobile robots 20 move. In the autonomous mobile robot control system 1, the images acquired by the plurality of environmental cameras 301 to 30n are collected by the host management device 10.

In the autonomous mobile robot control system 1 according to the first embodiment, the host management device 10 creates a path to the destination of the autonomous mobile robot 20 on the basis of route plan information, and indicates the destination to the autonomous mobile robot 20 according to this route plan. The autonomous mobile robot 20 then autonomously moves toward the destination indicated by the host management device 10. In the autonomous mobile robot control system 1 according to the first embodiment, the autonomous mobile robot 20 autonomously moves toward the destination by using a sensor mounted thereon, a floor map, position information and the like. Further, the host management device 10 updates the route plan so as to prevent the operation of the autonomous mobile robot 20 from interfering with the behavior of users of the facility by using the environmental cameras 301 to 30n.

Further, the autonomous mobile robot control system 1 according to the first embodiment divides a facility to be managed into a plurality of management areas and detects a moving object in each management area. Then, the autonomous mobile robot control system 1 evaluates a situation change for each management area, and updates route information for indicating a moving path of the autonomous mobile robot 20 on the basis of this evaluation.

The host management device 10 includes an arithmetic processing unit 11, a storage unit 12, a buffer memory 13, and a communication unit 14. The arithmetic processing unit 11 performs processing for controlling and managing the autonomous mobile robot 20. The arithmetic processing unit 11 may be implemented as a device capable of executing a program such as a central processing unit (CPU) of a computer, for example. Each function may be implemented by a program. Although a robot control unit 111, an environmental change estimation unit 112, and a route plan update processing unit 113, which are characteristic in the arithmetic processing unit 11, are shown in FIG. 1, other processing blocks may be included.

The robot control unit 111 performs computation for remotely controlling the autonomous mobile robot 20, and generates a specific motion instruction to be given to the autonomous mobile robot 20. The environmental change estimation unit 112 estimates the degree of congestion in each management area at the point of time later than the present time from the images of the management areas acquired by the environmental cameras 301 to 30n. The environmental change estimation unit 112 refers to a detected object database 124 stored in the storage unit 12, and identifies a moving object that has caused a change in the environment of the management area. Then, the environmental change estimation unit 112 records the evaluation result of the estimated degree of congestion into a current area evaluation value 127. The route plan update processing unit 113 refers to the current area evaluation value 127 stored in the storage unit 12 on the basis of the degree of congestion estimated by the environmental change estimation unit 112 and updates route plan information 125. The details of processing in the arithmetic processing unit 11 are described later.

The storage unit 12 is a storage unit that stores information necessary for management and control of the robot. In the example of FIG. 1, a floor map 121, robot information 122, a robot control parameter 123, the detected object database 124, the route plan information 125, a reference area evaluation value 126, and the current area evaluation value 127 are shown; however, information stored in the storage unit 12 may be different from them. The arithmetic processing unit 11 performs computation using the information stored in the storage unit 12 when carrying out processing.

The floor map 121 is map information of the facility in which the autonomous mobile robot 20 moves. This floor map 121 may be created in advance, may be generated from information obtained from the autonomous mobile robot 20, or may be generated by adding map correction information generated from information obtained from the autonomous mobile robot 20 to a basic map created in advance.

The robot information 122 describes the model number, the specification and the like of the autonomous mobile robot 20 managed by the host management device 10. The robot control parameter 123 describes a control parameter such as distance threshold information from an obstacle for each of the autonomous mobile robots 20 managed by the host management device 10.

The robot control unit 111 gives a specific motion instruction to the autonomous mobile robots 20 by using the robot information 122, the robot control parameter 123, and the route plan information 125. Further, the environmental change estimation unit 112 estimates an environmental change and generates an evaluation value for each management area by using the detected object database 124 and the reference area evaluation value 126.

The buffer memory 13 is a memory that accumulates intermediate information generated in the processing of the arithmetic processing unit 11. The communication unit 14 is a communication interface for communicating with the plurality of environmental cameras 301 to 30n and at least one autonomous mobile robot 20 that are placed in the facility where the autonomous mobile robot control system 1 is used. The communication unit 14 is capable of performing both of wired communication and wireless communication.

The autonomous mobile robot 20 includes an arithmetic processing unit 21, a storage unit 22, a communication unit 23, a proximity sensor (e.g., distance sensor group 24), a camera 25, a drive unit 26, a display unit 27, and an operation receiving unit 28. Although only typical processing blocks included in the autonomous mobile robot 20 are shown in FIG. 1, many other processing blocks which are not shown may be also included in the autonomous mobile robot 20.

The communication unit 23 is a communication interface for communicating with the communication unit 14 of the host management device 10. The communication unit 23 communicates with the communication unit 14 by using a radio signal, for example. The distance sensor group 24 is a proximity sensor, for example, and outputs nearby object distance information indicating the distance from an object or person existing around the autonomous mobile robot 20. The camera 25 takes an image for grasping the situation around the autonomous mobile robot 20, for example. Further, the camera 25 may take an image of a positional marker placed on the ceiling or the like of the facility, for example. The autonomous mobile robot control system 1 according to the first embodiment allows the autonomous mobile robot 20 to grasp its own position by using this positional marker. The drive unit 26 drives a drive wheel of the autonomous mobile robot 20. The display unit 27 displays a user interface screen, which functions as the operation receiving unit 28. Further, the display unit 27 may display information indicating the destination of the autonomous mobile robot 20 or the state of the autonomous mobile robot 20. The operation receiving unit 28 includes various types of switches mounted on the autonomous mobile robot 20, in addition to the user interface screen displayed on the display unit 27. The various types of switches include an emergency stop button, for example.

The arithmetic processing unit 21 performs computation used for controlling the autonomous mobile robot 20. To be specific, the arithmetic processing unit 21 includes a moving command extraction unit 211, a drive control unit 212, and a surrounding anomaly detection unit 213. Although only typical processing blocks included in the arithmetic processing unit 21 are shown in FIG. 1, processing blocks which are not shown may be included therein.

The moving command extraction unit 211 extracts a moving command from a control signal supplied from the host management device 10, and supplies it to the drive control unit 212. The drive control unit 212 controls the drive unit 26 so as to move the autonomous mobile robot 20 at the speed and in the direction indicated by the moving command supplied from the moving command extraction unit 211. Further, when the drive control unit 212 receives an emergency stop signal from the emergency stop button included in the operation receiving unit 28, it stops the motion of the autonomous mobile robot 20 and gives an instruction to the drive unit 26 so as not to generate a driving force. The surrounding anomaly detection unit 213 detects an anomaly occurring around the autonomous mobile robot 20 on the basis of information obtained from the distance sensor group 24 or the like, and supplies a stop signal for stopping the autonomous mobile robot 20 to the drive control unit 212. The drive control unit 212 that has received the stop signal gives an instruction to the drive unit 26 so as not to generate a driving force.

The storage unit 22 stores a floor map 221 and a robot control parameter 222. FIG. 1 shows only some of the information stored in the storage unit 22, and information other than the floor map 221 and the robot control parameter 222 shown in FIG. 1 are also stored in the storage unit 22. The floor map 221 is map information of the facility in which the autonomous mobile robot 20 moves. This floor map 221 may be obtained by downloading the floor map 121 of the host management device 10, for example. Note that the floor map 221 may be created in advance. The robot control parameter 222 is a parameter for putting the autonomous mobile robot 20 into motion, and it includes a motion limit threshold for stopping or limiting the motion of the autonomous mobile robot 20 on the basis of the distance from an obstacle or person, for example.

The drive control unit 212 refers to the robot control parameter 222 and stops the motion or limits the moving speed when the distance indicated by distance information obtained from the distance sensor group 24 falls below the motion limit threshold.

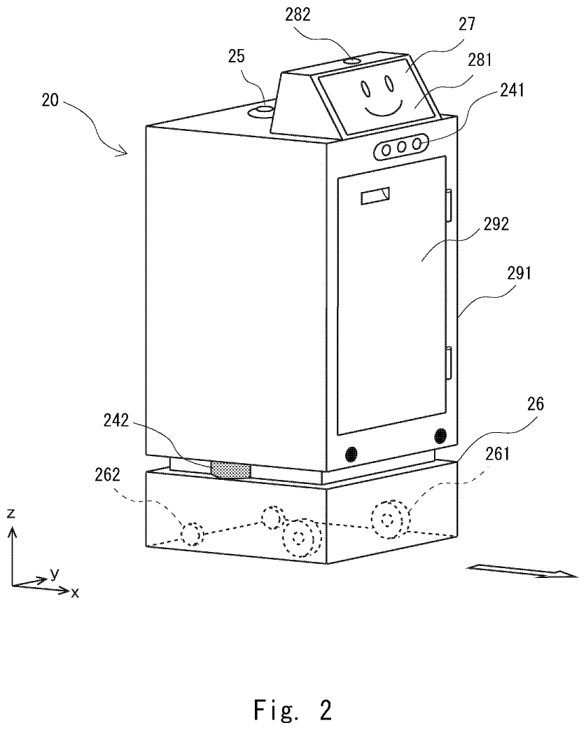

The exterior of the autonomous mobile robot 20 is described hereinafter. FIG. 2 shows a schematic view of the autonomous mobile robot 20 according to the first embodiment. The autonomous mobile robot 20 shown in FIG. 2 is one form of the autonomous mobile robot 20, and it may be in another form.

The example shown in FIG. 2 is the autonomous mobile robot 20 that includes a storage 291 and a door 292 that seals the storage 291. The autonomous mobile robot 20 carries a stored object stored in the storage 291 to the destination indicated by the host management device 10 by autonomous locomotion. In FIG. 2, the x-direction is the forward direction and the backward direction of the autonomous mobile robot 20, the y-direction is the leftward and rightward direction of the autonomous mobile robot 20, and the z-direction is the height direction of the autonomous mobile robot 20.

As shown in FIG. 2, a front and back distance sensor 241 and a left and right distance sensor 242 are mounted as the distance sensor group 24 on the exterior of the autonomous mobile robot 20 according to the first embodiment. The autonomous mobile robot 20 according to the first embodiment measures the distance from an object or person in the frontward and backward direction of the autonomous mobile robot 20 by using the front and back distance sensor 241. Further, the autonomous mobile robot 20 according to the first embodiment measures the distance from an object or person in the leftward and rightward direction of the autonomous mobile robot 20 by using the left and right distance sensor 242.

In the autonomous mobile robot 20 according to the first embodiment, the drive unit 26 is placed below the storage 291. The drive unit 26 includes a drive wheel 261 and a caster 262. The drive wheel 261 is a wheel for moving the autonomous mobile robot 20 forward, backward, leftward and rightward. The caster 262 is a driven wheel that has no driving force and turns following the drive wheel 261.

Further, in the autonomous mobile robot 20, the display unit 27, an operation interface 281, and the camera 25 are mounted on the top surface of the storage 291. Further, on the display unit 27, the operation interface 281 is displayed as the operation receiving unit 28. Furthermore, an emergency stop button 282 is mounted on the top surface of the display unit 27.

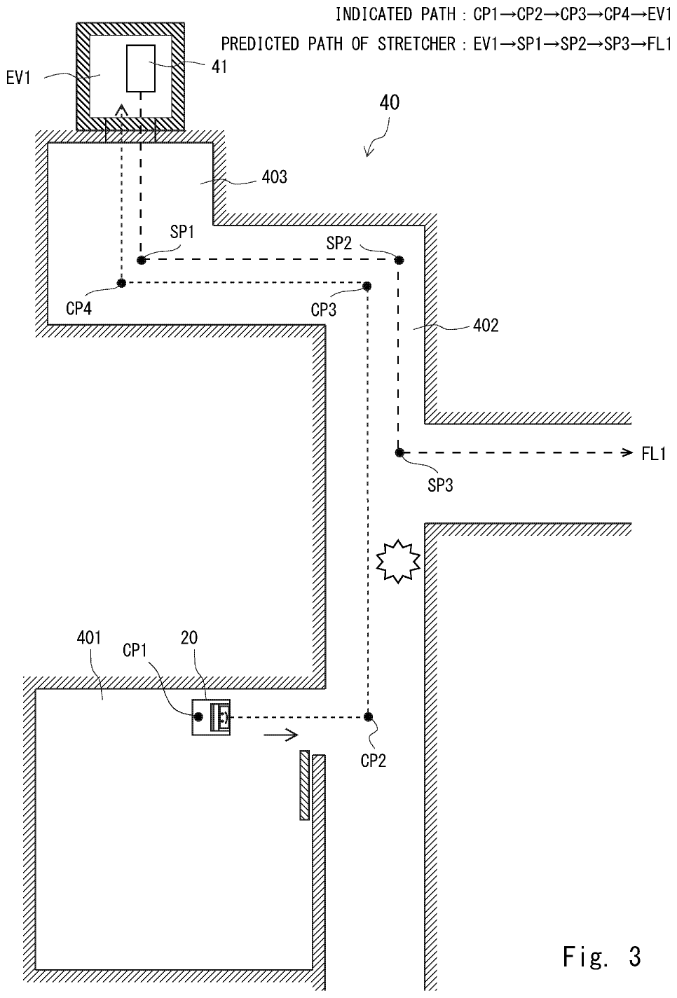

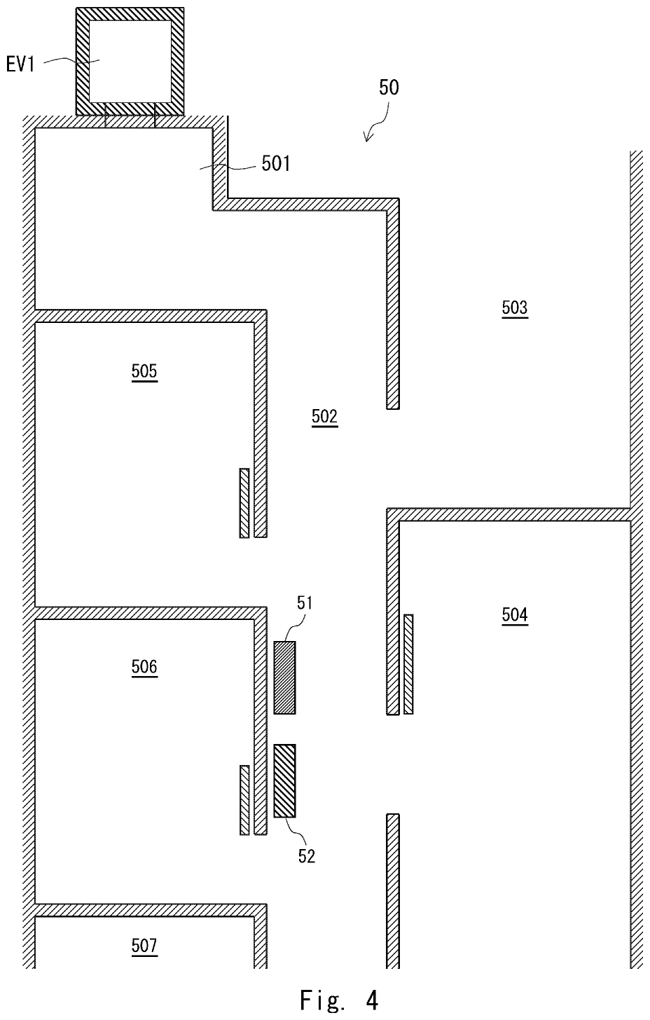

The operation of the autonomous mobile robot control system 1 according to the first embodiment is described hereinafter. When a person or object moves in a management area in which the autonomous mobile robot 20 is in operation, the movement of people becomes more active in some cases, and the autonomous mobile robot control system 1 according to the first embodiment updates a route plan so as to avoid a place where the degree of congestion of people increases in each management area. An example of the situation where the degree of congestion increases is described hereinafter with reference to FIGS. 3 and 4.

FIG. 3 is a view illustrating the situation where the movement lines of people and the autonomous mobile robot cross over, which occurs when the autonomous mobile robot 20 according to the first embodiment is put into operation. FIG. 3 shows a management area 40 that is set in the facility in which the autonomous mobile robot 20 is put into operation, and it shows a room 401, a corridor 402 connected to the room 401, an elevator EV1 located at the end of the corridor 402, and an elevator hall 403 located in front of the elevator EV1.

Further, in the example shown in FIG. 3, the autonomous mobile robot 20 starts at a starting point CP1 in the room 401 and moves along a path P1 that passes through the corridor 402 and the elevator hall 403 and reaches the elevator EV1. Further, in the example shown in FIG. 3, a stretcher 41 that has arrived by the elevator EV1 moves to a floor FL1, which is another management area, through a passage that is partly the same as the path given to the autonomous mobile robot 20.

In the example as shown in FIG. 3, if the movement of the stretcher 41 and the movement of the autonomous mobile robot 20 occur at the same time, the moving path of the stretcher 41 and the moving path of the autonomous mobile robot 20 cross over, which is a problem. Further, as the stretcher 41 moves, medical staff are likely to come and go frequently. In such a case, the autonomous mobile robot control system 1 updates route plan information 125 to modify the moving start time of the autonomous mobile robot 20 so that it waits until the flow of people caused by the movement of the stretcher 41 is reduced.

FIG. 4 is a view illustrating the situation where an object is placed in a passage for a certain period of time, which occurs when the autonomous mobile robot according to the first embodiment is put into operation. The example of FIG. 4 shows a management area 50 that is set in the facility in which the autonomous mobile robot 20 is put into operation, and it shows an elevator hall 501, a corridor 502 connected to the elevator hall 501, and a nurse station 503 and rooms 504 to 507 located on both sides of the corridor 502.

The example of FIG. 4 shows the case where a serving cart 51 and a soiled dish cart 52 are placed in the corridor 502 for a certain period of time. The serving cart 51 and the soiled dish cart 52 are placed stationary during predetermined meal times. When the serving cart 51 and the soiled dish cart 52 are placed, it is expected that people in the rooms 504 to 507 gather around the serving cart 51 or the soiled dish cart 52. In such a case, the autonomous mobile robot control system 1 updates route information so as to stop the operation of the autonomous mobile robot 20 in the management area 50 or reduce the moving speed of the autonomous mobile robot 20 passing through the management area 50, for example.

Note that the autonomous mobile robot control system 1 may monitor the serving trays picked up from the serving cart 51 or the serving trays returned to the soiled dish cart 52 by using the environmental cameras 301 to 30n, and update the route information according to the monitored conditions.

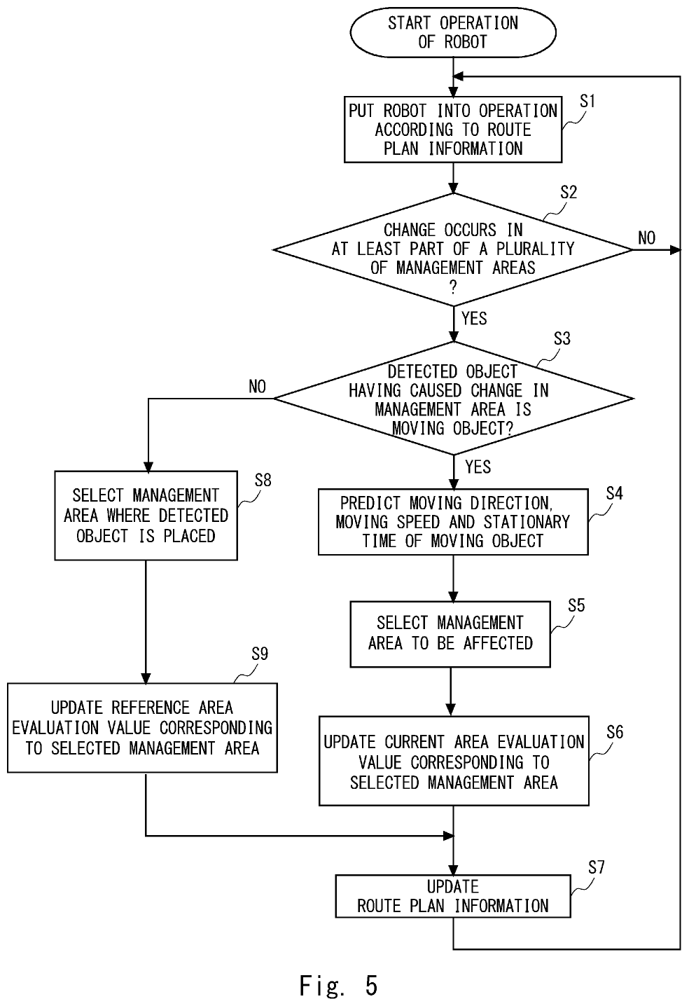

The operation of the autonomous mobile robot control system 1 according to the first embodiment is described hereinafter in detail. FIG. 5 is a flowchart illustrating the operation of the autonomous mobile robot control system 1 according to the first embodiment. FIG. 5 only shows a process related to the update of route information in the operation of the autonomous mobile robot control system 1 according to the first embodiment, and the autonomous mobile robot control system 1 also performs other processes related to the control of the autonomous mobile robot 20.

As shown in FIG. 5, after the autonomous mobile robot control system 1 starts operating the autonomous mobile robot 20, it puts the autonomous mobile robot 20 into operation according to the route plan information 125 (Step S1). Then, the autonomous mobile robot control system 1 continues to operate the autonomous mobile robot 20 on the basis of the route plan information 125 until a change of the environment occurs in at least part of a plurality of management areas where an environmental change is monitored by the environmental cameras 301 to 30n (No in Step S2). On the other hand, when a change of the environment occurs in at least part of a plurality of management areas (Yes in Step S2), the autonomous mobile robot control system 1 determines whether a detected object that has caused a change in the management area is a moving object or not (Step S3).

In Step S3, when the detected object that has caused a change in the management area is a moving object (Yes in Step S3), the autonomous mobile robot control system 1 estimates the moving direction, moving speed and the stationary time of the moving object by using the environmental change estimation unit 112 (Step S4). In the estimation of Step S4, the environmental change estimation unit 112 estimates the destination, the moving time, and the stationary time of the moving object in the period of time later than the present time on the basis of the past images acquired by the environmental cameras 301 to 30n, the characteristics of the moving object specified by referring to the detected object database 124, and the reference evaluation value supplied from the reference area evaluation value 126. Then, the environmental change estimation unit 112 selects the management area that is possibly affected on the basis of this estimation (Step S5), updates the evaluation value corresponding to the selected management area, and records the updated evaluation value in the current area evaluation value 127 (Step S6).

After that, the autonomous mobile robot control system 1 updates the route information where the management area that is considered to be affected by the detected object is included in the route by using the route plan update processing unit 113 (Step S7). In this Step S7, the route plan update processing unit 113 refers to the current area evaluation value 127. Further, the route plan update processing unit 113 updates the current area evaluation value 127 so as to prevent the autonomous mobile robot 20 from passing through the management area where the degree of congestion is estimated to be high or to reduce the speed limit when the autonomous mobile robot 20 passes through the management area where the degree of congestion is estimated to be high on the basis of the current area evaluation value 127.

On the other hand, in Step S3, when the environmental change estimation unit 112 determines that the detected object that has caused a change in the management area is a fixed object that is placed there constantly (No in Step S3), the environmental change estimation unit 112 selects the management area in which the fixed object is placed (Step S8). Then, the environmental change estimation unit 112 updates the evaluation value of the reference area evaluation value 126 corresponding to the selected management area to the evaluation value including the fixed object (Step S9). Further, the route plan update processing unit 113 updates the route plan information 125, following the update of the reference area evaluation value 126 in Step S9 (Step S7).

As described above, the autonomous mobile robot control system 1 according to the first embodiment detects the movement of an object that can cause a change in the movement of people in the facility where the autonomous mobile robot 20 is in operation by using the environmental cameras 301 to 30n. On the basis of this detection result, the autonomous mobile robot control system 1 updates the route plan information 125 so as to avoid the management area where the degree of congestion of people is estimated to be high or reduce the moving speed of the autonomous mobile robot 20 in this management area. The autonomous mobile robot control system 1 according to the first embodiment thereby reduces the frequency that the operation of the autonomous mobile robot 20 interferes with the flow of people.

### Second Embodiment

In a second embodiment, an autonomous mobile robot control system 2, which is a modified example of the autonomous mobile robot control system 1, is described. In the description of the second embodiment, the same elements as the elements described in the first embodiment are denoted by the same reference symbols as in the first embodiment, and the description thereof is omitted.

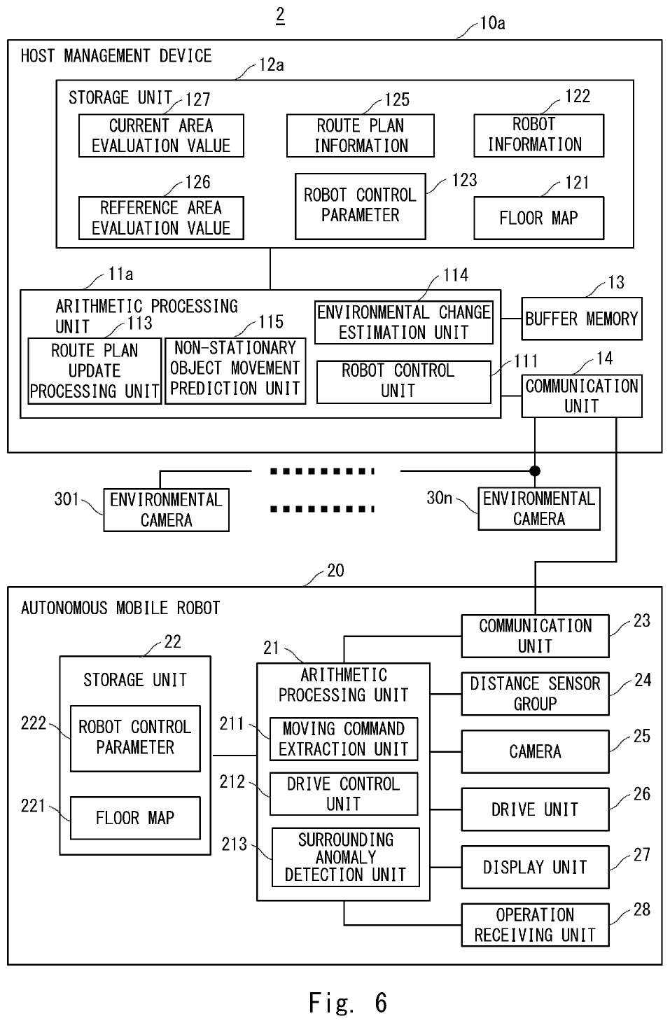

FIG. 6 is a block diagram of the autonomous mobile robot control system 2 according to the second embodiment. As shown in FIG. 6, in the autonomous mobile robot control system 2 according to the second embodiment, the host management device 10 in the autonomous mobile robot control system 1 is replaced with a host management device 10a. Further, in the host management device 10a, the arithmetic processing unit 11 is replaced with an arithmetic processing unit 11a, and the storage unit 12 is replaced with a storage unit 12a.

In the arithmetic processing unit 11a, the environmental change estimation unit 112 in the host management device 10 is replaced with an environmental change detection unit 114 and a non-stationary object movement prediction unit 115. In the storage unit 12a, the detected object database 124 in the storage unit 12 is eliminated.

The environmental change detection unit 114 detects a moving object from the images acquired using the environmental cameras 301 to 30n, and notifies the non-stationary object movement prediction unit 115 that the moving object is detected. The non-stationary object movement prediction unit 115 identifies the moving object from the images obtained from the environmental cameras 301 to 30n, and predicts the movement pattern of the identified moving object. The non-stationary object movement prediction unit 115 is a predictor using artificial intelligence, for example.

As described above, with the predictor using artificial intelligence, the autonomous mobile robot control system 2 according to the second embodiment is capable of predicting the movement pattern of a moving object more flexibly than the case of using static information stored in the database. Further, with use of the non-stationary object movement prediction unit 115, the autonomous mobile robot control system 2 according to the second embodiment is capable of predicting the movement pattern of a moving object more accurately than the autonomous mobile robot control system 1 according to the first embodiment. Therefore, the autonomous mobile robot control system 2 according to the second embodiment reduces the frequency that the autonomous mobile robot 20 interferes with the flow of people more significantly than the autonomous mobile robot control system 1 according to the first embodiment.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

For example, the arithmetic processing unit 11 and the storage unit 12 included in the host management device 10 may be located in a remote place which is distant from the facility where management areas are set through a network.

What is claimed is:

1. An autonomous mobile robot control system comprising:
an autonomous mobile robot;
a host management device configured to manage the autonomous mobile robot on the basis of a route plan defining a moving route of the autonomous mobile robot; and
a plurality of environmental cameras configured to capture images of a moving range of the autonomous mobile robot and transmit the captured images to the host management device, wherein
for each of a plurality of management areas defined by dividing an operating range of the autonomous mobile robot, the host management device estimates transition of a degree of congestion in the management area in a period later than present time on the basis of environmental information acquired using the plurality of environmental cameras, and
the host management device updates the route plan on the basis of an estimated result of transition of the degree of congestion.

2. The autonomous mobile robot control system according to claim 1, wherein the host management device updates the route plan so as to avoid the management area where the degree of congestion is high.

3. The autonomous mobile robot control system according to claim 1, wherein the host management device estimates a moving speed of a detected object having caused a change in the management area, a moving path of the detected object, or a staying time of the detected object in a place where the detected object is placed stationary from characteristics of the detected object, and estimates a degree of congestion in the plurality of management areas on the basis of estimated impact of the object on the management area.

4. The autonomous mobile robot control system according to claim 1, wherein when a detected object having caused a change in the management area is an object placed constantly in the management area, the host management device updates a reference area evaluation value set for each of the management areas and serving as a reference to determine an environmental change in the management area by adding the detected object placed constantly to the reference area evaluation value.

5. The autonomous mobile robot control system according to claim 4, wherein the host management device includes a current area evaluation value indicating a difference between a current environment and the reference area evaluation value for each of the management areas, and the current area evaluation value contains information about transition of the degree of congestion in a period later than present time estimated on the basis of the environmental information acquired by the plurality of environmental cameras.

6. The autonomous mobile robot control system according to claim 1, wherein the host management device estimates transition of a degree of congestion of people in the plurality of management areas in a period later than present time on the basis of a detected object having caused a change in the management area.

7. The autonomous mobile robot control system according to claim 1, wherein
the route plan contains information about a moving speed to be indicated to the autonomous mobile robot, and
the host management device updates the route plan so as to reduce a moving speed of the autonomous mobile robot in the management area where the degree of congestion is estimated to be high on the basis of estimation of transition of the degree of congestion.

8. An autonomous mobile robot control method in an autonomous mobile robot control system including a host management device configured to manage an autonomous mobile robot on the basis of a route plan defining a moving route of the autonomous mobile robot, and a plurality of environmental cameras configured to capture images of a moving range of the autonomous mobile robot and transmit the captured images to the host management device, comprising:
estimating, by the host management device, transition of a degree of congestion in a period later than present time in each of a plurality of management areas defined by dividing an operating range of the autonomous mobile robot on the basis of environmental information acquired using the plurality of environmental cameras; and
updating, by the host management device, the route plan on the basis of an estimated result of transition of the degree of congestion.

9. A non-transitory computer readable medium storing an autonomous mobile robot control program executed in a host management device of an autonomous mobile robot control system including the host management device configured to manage an autonomous mobile robot on the basis of a route plan defining a moving route of the autonomous mobile robot, and a plurality of environmental cameras configured to capture images of a moving range of the autonomous mobile robot and transmit the captured images to the host management device, the autonomous mobile robot control program causing a computer to execute:
estimating transition of a degree of congestion in a period later than present time in each of a plurality of management areas defined by dividing an operating range of the autonomous mobile robot on the basis of environmental information acquired using the plurality of environmental cameras; and
updating the route plan on the basis of an estimated result of transition of the degree of congestion.

10. An autonomous mobile robot control device comprising:
a host management device configured to manage an autonomous mobile robot on the basis of a route plan defining a moving route of the autonomous mobile robot; and
a plurality of environmental cameras configured to capture images of a moving range of the autonomous mobile robot and transmit the captured images to the host management device, wherein
for each of a plurality of management areas defined by dividing an operating range of the autonomous mobile robot, the host management device estimates transition of a degree of congestion in the management area in a period later than present time on the basis of environmental information acquired using the plurality of environmental cameras, and
the host management device updates the route plan on the basis of an estimated result of transition of the degree of congestion.
